(19) United States
(12) Patent Application Publication
(10) Pub. No.: US 2004/0004169 A1
(43) Pub. Date: Jan. 8, 2004

(54) Tissue packet holder

(76) Inventor: Mary K. Hays, Allison Park, PA (US)

Correspondence Address: William L. Krayer, 1771 Helen Drive, Pittsburgh, PA, 15216, US

(21) Appl. No.: 10/190,039

(22) Filed: Jul. 5, 2002

(51) Int. Cl. F16B 1/00; E04G 3/00; G09F 7/18; A47B 96/06

(52) U.S. Cl. 248/229.16; 248/905

(57) ABSTRACT

A bracket is designed to hold a small collapsible packet of tissues on an automobile visor, permitting ready access to individual tissues. The bracket has a generally S-shaped profile, forming clamps for the visor and the tissue packet. The clamping portions have sufficient clamping effect to assure the bracket is held on the visor even if the visor is turned down, and to assure the tissue packet is retained even if there is only one tissue left.

### TECHNICAL FIELD

A holder for a small collapsible packet of tissues is adapted to clamp to an automobile visor. Tissues may be removed from the packet without removing it from the holder and the packet remains firmly held until the tissues are depleted.

### BACKGROUND OF THE INVENTION

Automobile drivers and their guests have occasional need of tissues, but it can be distracting and unsafe to grope for them in a glove compartment or other compartment in the automobile. A holder for tissues within easy reach would be desirable from the standpoints of convenience and safety.

The holder should preferably be readily attached and filled with tissues. A bracket disclosed by Gross in U.S. Pat. No. 5,065,970 is designed to accommodate an entire box of tissues of the more or less standard size. While the bracket is designed to be fixed to an automobile visor, the rigidity of the box is utilized to help retain it in the bracket. That is, when the tissue box is inserted in the space between the bottom ledge of the bracket and the visor, the box fills the space between the bottom ledge and the visor, regardless of how full or empty the box. The Gross design is not useful for a small collapsible packet of tissues.

For those who do not desire or require an entire box of tissues, it would be convenient and less obtrusive to have a holder for a small packet of tissues. Such small packets have become more or less standard in dimensions, being generally rectangular—about 2 and ¼ inches by about 4½ inches, and one-half inch to an inch thick. However, these common packets have no rigid sides. Not having the rigid construction of a box, they would collapse within a rigid container such as proposed by Gross for a full box of tissues, even if the Gross box were sized appropriately.

### SUMMARY OF THE INVENTION

My invention is designed specifically to accommodate a small collapsible packet of tissues of the more or less standard size mentioned above, i.e. about 2 and one quarter inches wide by about 4 and one-half inches long by about ¾ inches thick. My invention should not be considered limited to such specific dimensions, however; it is directed to a collapsible container of tissues such as are marketed in and held by a thin normally transparent wrap. Such packets of tissues typically are designed with a tab or other opening to permit sequential dispensing of the tissues.

My invention comprises a resilient S-profile bracket of material and dimensions capable of clamping to the visor and also to the packet of tissues. The lower ledge of the bracket that is, the ledge designed to hold the tissues—should have an open area near its center to facilitate removal of tissues one at a time, preferably through the opening normally found in such a packet. The material of construction should be resilient so that it will return to the original shape after it is bent to clamp to the visor and the tissue pack.

Thus, my invention may be said to include a visor bracket for a packet of tissues comprising an upper support, a central ledge, and a lower ledge, a first connecting member connecting the upper support from an edge thereof to the central ledge at a first edge of the central ledge, a second connecting member connecting the lower ledge from an edge thereof to a second edge of the central ledge, the second edge of the central ledge being opposite the first edge thereof, the upper support, first connecting member, central ledge, second connecting member, and lower ledge thereby forming a bracket having an S-shaped profile, the bracket further being resilient so as to be capable of clamping onto an automobile visor between the upper support and the central ledge and retaining a collapsible packet of tissues between the central ledge and the lower ledge.

### BRIEF DESCRIPTION OF THE DRAWINGS

FIG. 1a is a perspective view of my preferred tissue visor bracket, without a tissue packet.

FIG. 1b shows the bracket of FIG. 1a installed on an automobile visor and filled with a tissue packet.

FIGS. 2a and 2b show an alternate design made of wire.

FIG. 3 is a further alternate bracket design.

FIG. 4 is an underside view of another alternate lower ledge.

FIGS. 5 and 6 are also underside views of other lower ledge designs within my invention.

### DETAILED DESCRIPTION OF THE INVENTION

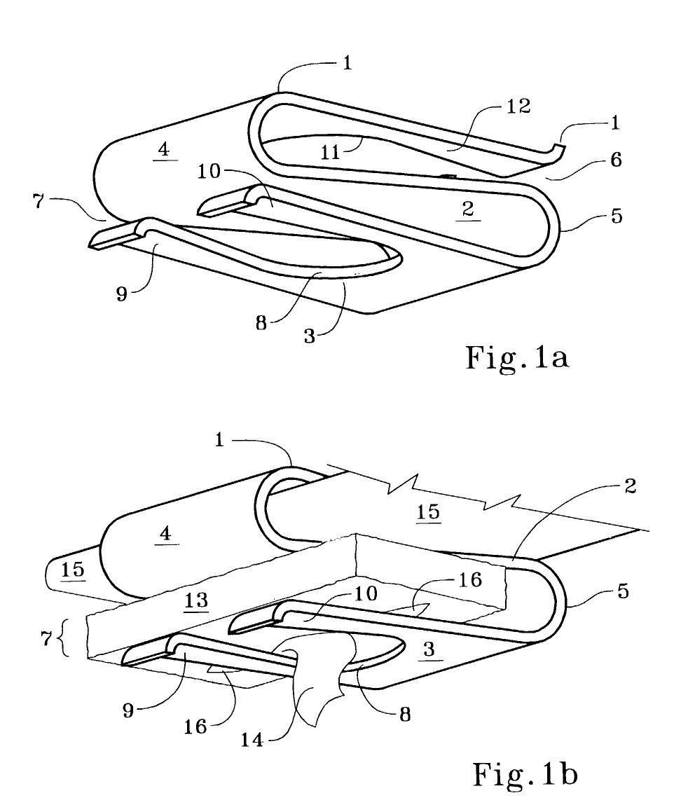

Referring now to FIG. 1a, my preferred bracket is made of a sheet of thermoplastic material which has been formed into the substantially S-shaped profile shown, having an upper support 1, a central ledge 2, and a lower ledge 3. The preferred unitary device has a connecting member 4 connecting the edges of upper support 1 and central ledge 2, and a connecting member 5 connecting an edge of lower ledge 3 and central ledge 2. The connecting members 4 and 5 integrate with central ledge 2 at opposite ends of central ledge 2, thus forming the generally S-shaped profile shown. While upper support 1 and central ledge 2 may be substantially parallel, it is preferred that they converge from the separation effected by connecting member 4 to a constricted opening 6. Connecting member 4 should be wide enough to accommodate the width of a typical automobile visor, i.e. about one-half inch, and should have a degree of resiliency sufficient to assure a clamping effect on a visor placed between upper support 1 and central ledge 2. Lower ledge 3 converges from the width of its connecting member 5 to a constricted opening 7 near connecting member 4, at the end of central ledge 2. While the end of lower ledge 3 need not necessarily directly contact central ledge 2, it should be close enough, if it does not contact, that even a tissue packet with one tissue left in it will be retained in the space between lower ledge 3 and the underside of central ledge 2.

Lower ledge 3 is designed in this configuration to have a U-shaped opening 8 for tissues to be removed directly from the tissue packet secured between lower ledge 3 and central ledge 2, as will be further discussed in FIG. 1b. The U-shaped opening 8 is formed by two prongs, 9 and 10. For ease of manufacture and possibly economy of material, a similar U-shaped opening 11 may be made in upper support 1, shown in FIG. 1a as having prong 12. While opening 8 is useful for the ready removal of tissues from a packet held between lower ledge 3 and central ledge 2, opening 11, and the prongs 12 in support I are optional. However, it should be recognized that the configuration of FIG. 1a is symmetrical and reversible—that is, support 1 and lower ledge 3 may be used in reverse roles. For manufacturing, this means the bracket may be fabricated from a sheet of thermoplastic by cutting the two U-shaped openings 8 and 11 from a generally rectangular sheet, heating the areas of incipient connecting members 4 and 5 to form them as shown, and permitting them to cool and stiffen to the shape shown. It will not matter then, how the bracket is oriented on the visor since both support 1 and lower ledge 3 will have an opening 8 suitable for removing tissues from the packet.

In FIG. 1b, the bracket of FIG. 1a is illustrated in place on the visor 15, and it holds a tissue packet 13. A sheet of tissue 14 projects from the packet 13 through packet slit 16 and bracket opening 8, conveniently ready for use by the driver, who need only reach up to extract it. Visor 15 was inserted into constricted opening 6, which now has the opening dimension of the visor 15; likewise, the substantially full tissue packet 13 causes constricted opening 7 to be widened, while the resilient properties of connecting member 5 exerts enough pressure, through lower ledge 3 and prongs 9 and 10, on tissue packet 13 to hold it in place. The resiliency of connecting members 4 and 5 should be sufficient to retain the bracket and the tissue packet in place on the visor even if the visor is turned down. Likewise, connecting member 5 exerts pressure on the tissue packet 13 as its thickness diminishes, particularly until there is as few as one tissue left in the packet. At that point, the lower ledge 3 will be oriented substantially as depicted in FIG. 1a.

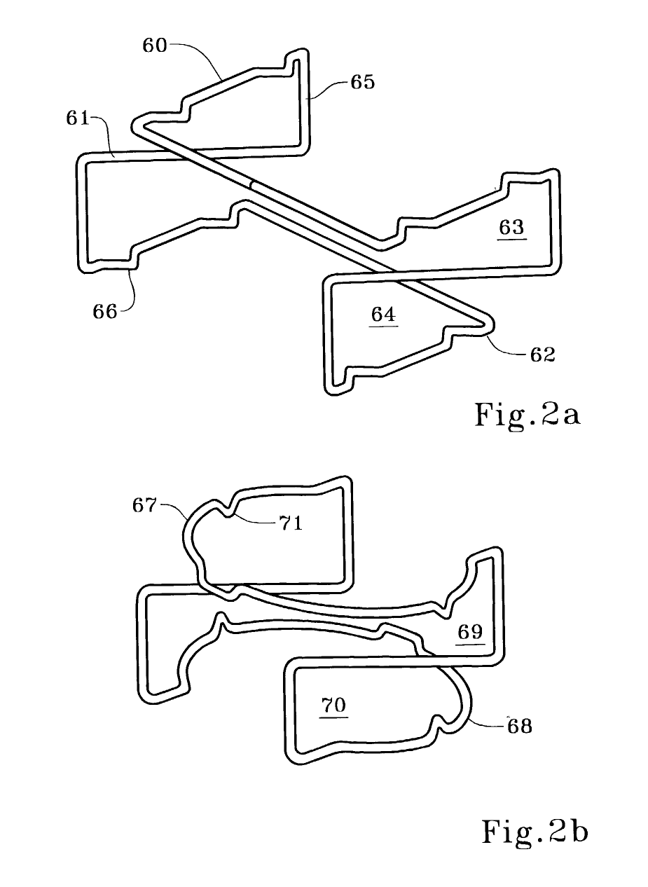

Referring now to FIG. 2a, it is seen that wire may be used to form a shape functionally similar to that of FIGS. 1a and 1b. Here, members 60 and 62 are similar in function to upper support 1 and lower ledge 3 in FIG. 1a, segment 65 is similar to connecting member 4, and the wire frame is formed to provide spaces 63 and 64 for the visor and tissue pack. The edge 62 of the lower ledge converges toward central ledge 61. At 66, it is seen that the wire can be formed into a shape designed to enhance the holding capability of a ledge, by bending it on the plane of the lower ledge. The variation of FIG. 2a is symmetrical. In FIG. 2b, the wire is formed slightly differently, showing nubs 71 which project into the space where the visor and tissue pack will be—that is, the nubs 71 are not on the same plane as the ledges. Spaces 69 and 70 are configured functionally substantially as in FIGS. 1a and 1b. As with the thermoplastic or other material used in the planar design of FIGS. 1a and 1b, the wire should have a resiliency such that it will hold firmly to the visor and also to the tissue pack even with only one tissue left.

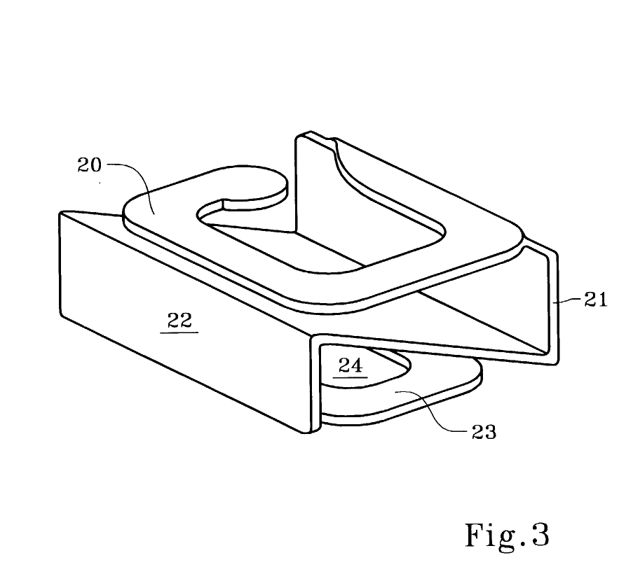

The variation of FIG. 3 shows a substantially hook-shaped upper ledge member 20 and substantially planar connecting members 21 and 22. Lower ledge 23 may also be substantially hook-shaped in order to make the bracket vertically reversible as is the unit of FIGS. 1a and 1b. The hook shaped ledge members 20 and 23 define a central opening 24 big enough to permit the ready extraction of a tissue from a tissue pack while still holding it firmly. Again, the resilience of connecting members 21 and 22 provide a clamping action on the visor and tissue packet respectively; in the case of the tissue packet, connecting member 22 will cause lower ledge member 23 to gradually close on the tissue packet as it is depleted. Unlike FIGS. 1a and 1b, however, this bracket is dimensioned so that the tissue packet will not project from the sides as in FIG. 1b—that is, the overall dimensions of the bracket are such that a standard tissue packet 34 will occupy substantially the same volume as is covered by the bracket.

FIG. 4 shows the face shape of an alternative lower ledge (viewed from the under side). Here, arms 30 and 31 are functionally similar to prongs 9 and 10 of FIG. 1a. The edge 32, as depicted, connects to a connecting member functionally similar to connecting members 5 and 22 of FIGS. 1a and 3. Again, the same design can be used for the upper ledge (mostly obscured here), but need not be, since there is no need for an opening 33 in upper support 1 (FIG. 1a).

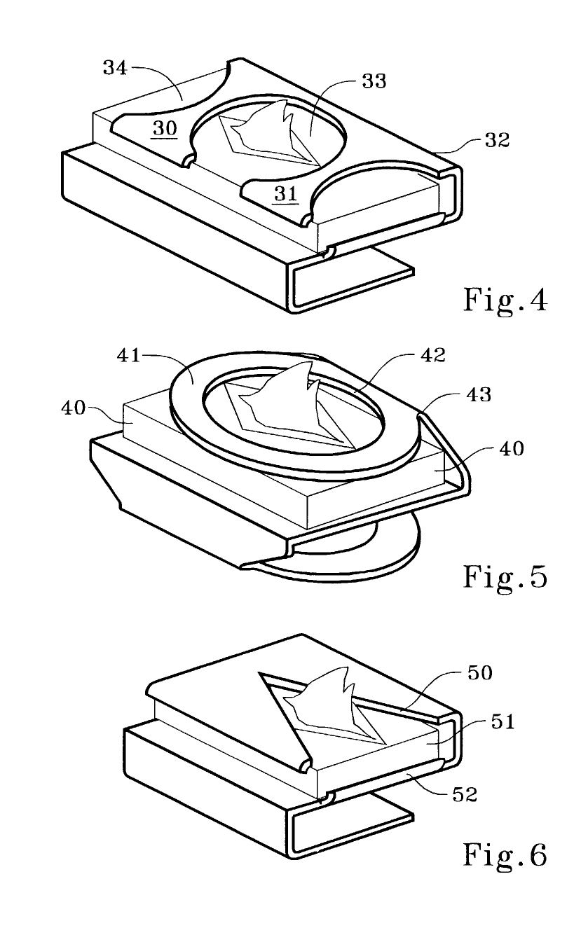

FIG. 5 (also a view from the underside) illustrates that the lower ledge need not have prongs—it is sufficient if there is an opening in the lower ledge permitting the extraction of a tissue from the packet 40. Thus, here, the lower ledge 41 is oval-shaped with an oval opening 42. As with edge 32 of FIG. 4, edge 43 is connected to a connecting member functionally similar to connecting members 5 and 22 of FIGS. 1a and 3, so the tissue packet 40 is continuously held in place.

FIG. 6 shows yet another design for the underside lower ledge. Here, the opening 50 for the tissues is angular and three of the outer edges of the ledge form a substantially rectangular shape to accommodate a contiguous tissue packet 51. The design is similar in function to the open-ended hook shape of FIG. 3. An optional flange 52 may be used to assure retention of the tissue packet 51 in its place.

The materials used in my invention are important only in that the construction should provide the clamping effects described above for the visor and the tissue packet. Useful materials include both thermoplastic and thermosetting synthetics, either of which may be filled with various common fillers or fiber reinforcements. They may be formed and/or fabricated from sheet material or molded, i.e. compression molded or injection molded. In the case of wire, again, it should be capable of returning to an original shape after providing the necessary clamping effects. Wire designs can emulate the shapes of the drawings herein. Sheet metal can also be used, provided it will clamp the tissue packet and retain its position on the visor in ordinary usage.

Thus my invention includes a visor bracket for a packet of tissues comprising an upper support, a central ledge, and a lower ledge, a first connecting member connecting the upper support from an edge thereof to the central ledge at a first edge of the central ledge, a second connecting member connecting the lower ledge from an edge thereof to a second edge of the central ledge, the second edge of the central ledge being opposite the first edge thereof, the upper support, first connecting member, central ledge, second connecting member, and lower ledge thereby forming a bracket having an S-shaped profile, the bracket further being resilient so as to be capable of clamping onto an automobile visor between the upper support and the central ledge and retaining a collapsible packet of tissues between the central ledge and the lower ledge, the lower ledge also defining a central opening for tissues to be removed from the collapsible tissue packet. In another aspect, my invention includes a bracket for dispensing tissues from under an automobile visor comprising an upper resilient clamp for attaching the bracket to the visor and a lower resilient clamp connected thereto for clamping a collapsible tissue packet, the lower resilient clamp being capable of retaining the collapsible tissue packet throughout its tenure of use while permitting tissues to be removed from the packet without moving the packet out of the bracket. Also, in another aspect, my invention includes a tissue holder for an automobile comprising a formed sheet of thermoplastic, the sheet having been formed and fabricated to a profile of dimensions providing a visor recess and a tissue packet recess, the visor recess being capable of clamping on an automobile visor and the tissue packet recess being capable of clamping on a collapsible tissue packet in both a full condition and an empty condition, the formed sheet including defining an opening for withdrawing tissues from a tissue packet in the tissue packet holder.

1. A visor bracket for a packet of tissues comprising an upper support, a central ledge, and a lower ledge, a first connecting member connecting said upper support from an edge thereof to said central ledge at a first edge of said central ledge, a second connecting member connecting said lower ledge from an edge thereof to a second edge of said central ledge, said second edge of said central ledge being opposite said first edge thereof, said upper support, first connecting member, central ledge, second connecting member, and lower ledge thereby forming a bracket having an S-shaped profile, said bracket further being resilient so as to be capable of clamping onto an automobile visor between said upper support and said central ledge and retaining a collapsible packet of tissues between said central ledge and said lower ledge, said lower ledge also defining a central opening for tissues to be removed from said collapsible packet.

2. A visor bracket of claim 1 wherein said capability of retaining a collapsible packet of tissues includes sufficient clamping force to hold both a full packet of tissues and a packet containing only one tissue.

3. A visor bracket of claim 2 made of thermoplastic.

4. A visor bracket of claim 2 made of wire.

5. A visor bracket of claim 1 wherein at least one of said upper support and said lower ledge has projecting nubs for enhancing the clamping effect of said bracket.

6. A visor bracket of claim 1 which is substantially symmetrical.

7. A visor bracket of claim 1 wherein at least one of said upper support and said lower ledge comprise prongs.

8. A bracket for dispensing tissues from under an automobile visor comprising an upper resilient clamp for attaching said bracket to said visor and a lower resilient clamp connected thereto for clamping a collapsible tissue packet, said lower resilient clamp being capable of retaining said collapsible tissue packet throughout its tenure of use while permitting tissues to be removed from said packet without moving said packet out of said bracket.

9. A bracket of claim 8 wherein said lower resilient clamp has a clamping force sufficient to hold either a full packet of tissues or a packet containing only one tissue.

10. A bracket of claim 8 wherein said lower resilient clamp defines an oval-shaped opening for removing tissues from said tissue packet.

11. A bracket of claim 8 wherein said lower resilient clamp is substantially hook-shaped.

12. A bracket of claim 8 which is substantially symmetrical.

13. A bracket of claim 8 made of thermoplastic.

14. A bracket of claim 13 comprising a monolithic formed sheet.

15. A bracket of claim 8 made of wire.

16. A tissue holder for an automobile comprising a formed sheet comprising synthetic polymer, said sheet having been formed and fabricated to an S-shaped profile of dimensions providing a visor recess and a tissue packet recess, said visor recess being capable of clamping on an automobile visor and said tissue packet recess defined by a central ledge and a lower ledge converging toward said central ledge and being capable of clamping on a collapsible tissue packet in both a full condition and an empty condition, said formed sheet including an opening in said lower ledge for withdrawing tissues from a tissue packet in said tissue packet recess.

17. A tissue holder of claim 16 wherein said opening is substantially oval.

18. A tissue holder of claim 16 wherein said synthetic polymer has a resiliency sufficient to retain said tissue holder on said automobile visor even when it is turned down.

19. A tissue holder of claim 16 wherein said synthetic polymer is a thermoplastic.

20. A tissue holder of claim 16 wherein said synthetic polymer is a thermosetting polymer.
